(19) United States
(12) Patent Application Publication
(10) Pub. No.: US 2012/0040682 A1
(43) Pub. Date: Feb. 16, 2012

(54) PRIORITIZATION OF DATA COMMUNICATION

(75) Inventors: Samir M. Hodroj, Bellevue, WA (US); Omar A. Hassan, Bellevue, WA (US)

(73) Assignee: T-Mobile USA, Inc., Bellevue, WA (US)

(21) Appl. No.: 12/856,494

(22) Filed: Aug. 13, 2010

(51) Int. Cl. H04W 72/10

(52) U.S. Cl. 455/450

(57) ABSTRACT

Communicating data between multiple devices based on an assigned priority is described. In one aspect, data associated with a local device is received for communication between the local device and a second device. A priority is assigned to the received data based on whether the received data is live voice data. The received data then is communicated between the local device and the second device based on the priority assigned to the received data.

### BACKGROUND

Many types of devices and systems communicate data between one another via one or more communication links. These communication links typically have a limited bandwidth available to communicate data and other information. When multiple devices (or multiple data streams) share a common communication link, the bandwidth associated with that link is allocated among the multiple devices (or multiple data streams). In some situations, this allocation of bandwidth may result in delayed communication of certain data.

When allocating bandwidth among multiple devices, or multiple data streams, certain devices or types of data may be given priority over other devices or data types. For example, time-critical data associated with a live-streamed event may be given priority over other types of data that are not time-critical, such as email messages. Therefore, in situations where bandwidth is shared among multiple devices or multiple data streams, it is desirable to prioritize data for communication using the available bandwidth.

### BRIEF DESCRIPTION OF THE DRAWINGS

In the Figures, the left-most digit of a component reference number identifies the particular Figure in which the component first appears.

FIG. 1 shows an exemplary environment capable of implementing the systems and methods described herein, according to one embodiment.

FIG. 2 is a block diagram showing various components of an exemplary data communication gateway, according to one embodiment.

FIG. 3 shows an exemplary procedure for assigning a data handling priority to received data, according to one embodiment.

FIG. 4 shows an exemplary procedure for determining a data handling priority to assign to received data, according to one embodiment.

FIG. 5 is a block diagram showing an exemplary local device, according to one embodiment.

### DETAILED DESCRIPTION

### Overview

The systems and methods described herein relate to the assignment of communication bandwidth to different types of data. These systems and methods use a data prioritization approach that assigns higher data communication priority to certain types of data. For example, voice data may be given higher priority than other types of data. Additionally, data having a particular format can be given a higher priority than data having other formats. Other data prioritization approaches assign a higher priority to data associated with devices from a particular manufacturer.

Although particular examples discussed herein relate to a data communication gateway, the present invention is applicable to any type of data communication device. The specific devices and communication links discussed herein are provided for purposes of discussion and to provide an exemplary implementation of the invention. The present invention is applicable to any type of data received from any type of device in any operating environment.

### An Exemplary System for Prioritizing Data Communication

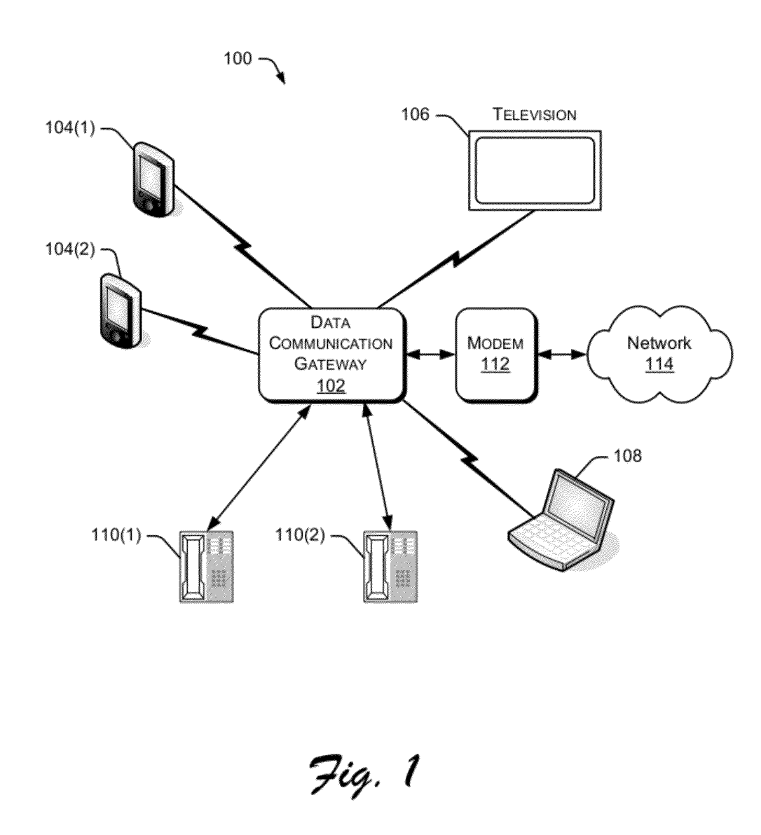

FIG. 1 shows an exemplary environment 100 capable of implementing the systems and methods described herein, according to one embodiment. Environment 100 includes a data communication gateway 102 that operates as a central hub for voice, data services and messaging communication between multiple devices. Data communication gateway 102 includes router functionality for communicating data between various networks and devices. Data communication gateway 102 further includes WiFi functionality for sending and receiving data using a WiFi network.

As shown in FIG. 1, data communication gateway 102 is coupled to two portable phones 104(1) and 104(2), a television 106, a computer 108 and two telephones 110(1) and 110(2). In alternate environments, any type of device can be coupled to data communication gateway 102, such as tablet computers, game consoles, portable entertainment systems, and so forth. In a particular embodiment, portable phones 104(1) and 104(2) are DECT (Digital Enhanced Cordless Telecommunications) phones, which are cordless phones that can be used in a local environment. DECT phones typically communicate with a base station, which is connected to a phone line or data communication network. In the embodiment of FIG. 1, the base station functionality is contained within data communication gateway 102, thereby eliminating the need for a separate base station. Although two portable phones 104(1) and 104(2) are shown in FIG. 1, particular implementations of data communication gateway 102 can support any number of portable phones.

In an alternate embodiment, phones 104(1) and 104(2) communicate with data communication gateway 102 via a WiFi communication link. In this embodiment, the data communicated between phones 104(1), 104(2) and data communication gateway 102 may be native UMA (Unlicensed Mobile Access) voice data.

Television 106 displays various data received from data communication gateway 102, such as program information, video content, audio content, web site content, and so forth. In the embodiment of FIG. 1, television 106 communicates with data communication gateway 102 via a WiFi communication link using the DLNA (Digital Living Network Alliance) specification. Through the communication link with data communication gateway 102, television 106 is capable of communicating with Internet-based web servers to retrieve content and interact with those servers.

Computer 108 is shown in FIG. 1 as a laptop or netbook style of computing device. Alternate embodiments may include any type of computing device, such as a desktop computer, a tablet, a handheld computer, a set top box, a game console, and the like. Computer 108 communicates with data communication gateway 102 via a WiFi communication link or other wireless communication system. In alternate embodiments, computer 108 may communicate with data communication gateway 102 via a wired communication link using any data communication protocol.

Telephones 110(1) and 110(2) are traditional telephones that are coupled to data communication gateway 102 via a traditional telephone cable. In a particular implementation, data communication gateway 102 includes support for two telephones. Alternate embodiments of data communication gateway 102 include support for any number of telephones. In one implementation, voice data associated with telephones 110(1) and 110(2) is communicated to other telephones via the Internet or other data communication network.

Data communication gateway 102 is also coupled to a modem 112, which is coupled a data communication network 114, such as the Internet. Modem 112 communicates with a variety of web servers and other resources accessible via data communication network 114. Data communication network 114 may include any number of data communication networks, such as local area networks (LANs), wide area networks (WANs), and the like.

As used herein, the term “local device” collectively refers to phones 104(1) and 104(2), television 106, computer 108 and telephones 110(1) and 110(2). These devices are generally referred to as “local devices” due to their proximate location to data communication gateway 102 and their ability to communicate with the gateway.

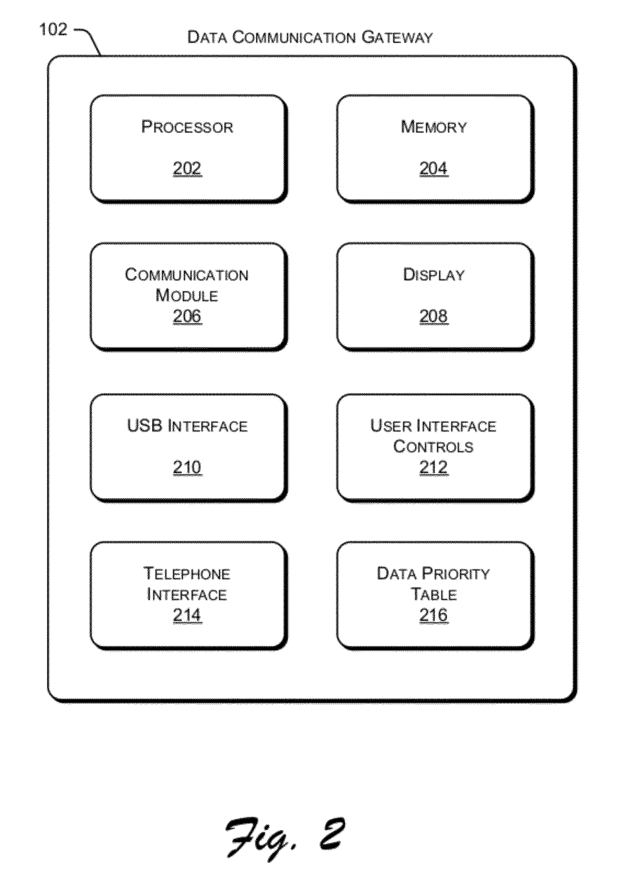

FIG. 2 is a block diagram showing various components of an exemplary data communication gateway, according to one embodiment. Data communication gateway 102 includes a processor 202, a memory 204, and a communication module 206. Processor 202 executes various instructions to implement the functions described herein. Memory 204 stores the instructions and other data used by processor 202 and other modules contained in data communication gateway 102. Communication module 206 allows data communication gateway 102 to communicate with other devices and systems, such as the systems and devices shown in FIG. 1. Additionally, communication module 206 allows data communication gateway 102 to communicate with devices and systems via data communication network 114 shown in FIG. 1.

Data communication gateway 102 also includes a display 208, a USB (Universal Serial Bus) interface 210 and user interface controls 212. Display 208 presents information to a user of data communication gateway 102, such as operating information, configuration settings and menu navigation information. USB interface 210 allows data communication gateway 102 to communicate with other devices using a USB port. A particular implementation of data communication gateway 102 includes two USB ports. User interface controls 212 include buttons, LEDs (light-emitting diodes) and the like to receive instructions from a user of data communication gateway 102 and to communicate information to the user in combination with display 208, as discussed above.

Data communication gateway 102 also includes a telephone interface 214 for communicating with one or more conventional telephones, such as telephones 110(1) and 110(2) shown in FIG. 1. Data received via telephone interface 214 is communicated to other devices or systems connected directly to data communication gateway 102 or coupled to the gateway via data communication network 114. Data communication gateway 102 further includes a data priority table 216 that contains information used to prioritize data communications. Data priority table 216 assigns various data throughput handling priorities based on the source of the received data, the type of received data and the manufacturer of the device communicating the received data. Additional details regarding the application of the information in data priority table 216 are discussed herein.

### An Exemplary Procedure for Prioritizing Data Communication

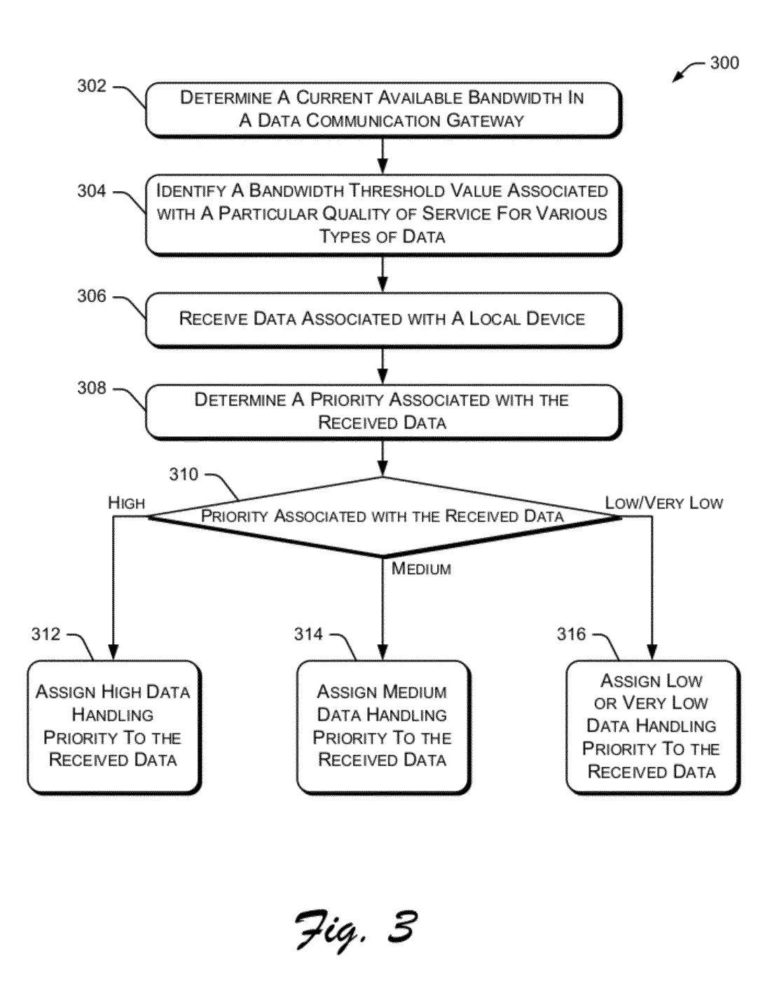

FIG. 3 shows an exemplary procedure 300 for assigning a data handling priority to received data, according to one embodiment. Initially, procedure 300 determines a current available bandwidth in a data communication gateway (block 302). This available bandwidth may be shared by multiple devices and/or multiple data streams. For example, the available bandwidth may be shared by live voice data, data services and messaging communications. Certain types of data, such as live voice data, may require a minimum bandwidth to ensure a particular quality of service (e.g., intelligible voice transmission) for that type of data. Thus, procedure 300 continues by identifying a bandwidth threshold value associated with a particular quality of service for various types of data supported by the system (block 304). Certain types of data, such as live voice data, may have a bandwidth threshold value (e.g., minimum bandwidth needed to ensure acceptable voice quality) while other types of data may not have a bandwidth threshold value.

The procedure of FIG. 3 continues by receiving data associated with a local device (block 306). As mentioned above, a local device is any device coupled to data communication gateway 102 shown in FIG. 1. Receiving data associated with a local device includes data received by the data communication gateway from the local device or data received by the data communication gateway for communication to the local device. In particular implementations, the received data is a request to establish a communication link between a local device and another system or device. Such request may be referred to as a “reservation request” or a “bandwidth reservation request”.

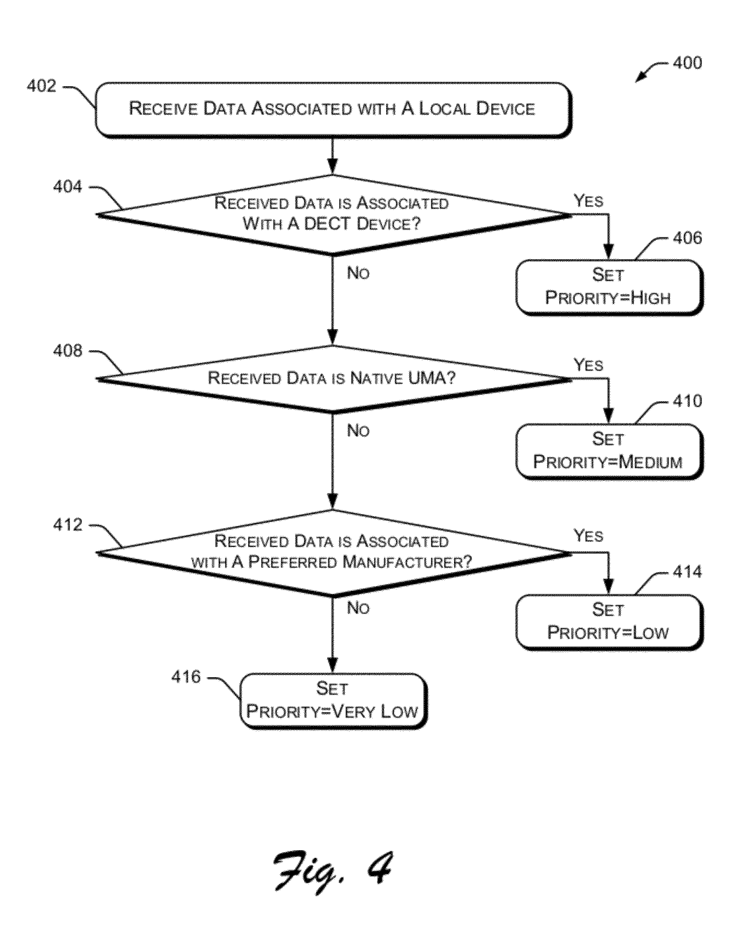

Procedure 300 then determines a priority associated with the received data (block 308). The procedure for determining this priority is discussed herein with respect to FIG. 4. Based on the priority associated with the received data (block 310), a data handling priority is assigned to the received data. In a particular embodiment, the assigned priority is “high”, “medium”, or “low” (blocks 312, 314 and 316, respectively). The data communication gateway uses the assigned priority to allocate available bandwidth to the received data as well as other data being handled by the data communication gateway.

FIG. 4 shows an exemplary procedure 400 for determining a data handling priority to assign to received data, according to one embodiment. Initially, procedure 400 receives data associated with a local device (block 402). The procedure then determines whether the received data is associated with a DECT (Digital Enhanced Cordless Telecommunications) device (block 404). This determination may include inspecting the type and size of data packet received as well as a destination port associated with the data. In other embodiments, the data may be tagged with metadata or other information that indicates the data type, data source, or data format. If the received data is associated with a DECT device, the data handling priority is set to “High” (block 406). DECT devices, such as DECT phones, are assigned the highest data handling priority to ensure that the live voice data associated with the DECT device is communicated in a manner that provides a clear understanding of the voice data to a user.

If the received data is not associated with a DECT device, procedure 400 determines whether the received data is native UMA (Unlicensed Mobile Access) voice data (block 408). If the received data is native UMA voice data, the data handling priority is set to “Medium” (block 410). The native UMA voice data is assigned a Medium priority to provide a good quality of data handling for the voice data. Thus, data associated with a DECT device is higher priority than native UMA voice data, but native UMA voice data has a higher priority than non-voice data discussed below.

If the received data is not associated with a DECT device and is not native UMA voice data, procedure 400 determines whether the received data is associated with a preferred manufacturer (or a preferred service provider) at block 412. If the data is associated with a preferred manufacturer or preferred service provider, the data handling priority is set to “Low” (block 414). If the data is not associated with a preferred manufacturer or preferred service provider, the data handling priority is set to “Very Low” (block 416). Thus, non-voice data associated with one or more preferred manufacturers or service providers may be given priority over non-voice data associated with other manufacturers or service providers. In alternate embodiments, all non-voice data is assigned a “Low” data handling priority, regardless of the manufacturer or service provider associated with the data.

Although the example of FIG. 4 assigns one of four different data handling priorities to specific data, alternate embodiments may use any number of data handling priorities associated with various types of data. In a particular embodiment, bandwidth is allocated to the different data handling priorities on a percentage basis. For example, if a DECT device has voice data to communicate and other devices are communicating non-voice data, the DECT device is allocated a percentage of bandwidth sufficient to communicate the voice data with the desired level of quality. The remaining bandwidth is allocated to the other devices communicating non-voice data. In this embodiment, if the available bandwidth is less than the minimum bandwidth required for the DECT device, the system will allocate 90% of the bandwidth to the DECT device and share the remaining 10% with the other devices.

The systems and method described herein are intended to give priority to voice data to ensure a good user experience when communicating voice data through the data communication gateway. This data priority is particularly important in situations where the available bandwidth is insufficient to handle all data simultaneously. For example, if a user is talking on a DECT phone and another user is browsing the Internet using the same data communication gateway, the data associated with the DECT phone is given priority over the Internet browser data. If there is sufficient bandwidth to handle both data streams simultaneously, then both users will have full access to the necessary bandwidth for their communications. However, if there is insufficient bandwidth to handle both data streams, the DECT phone data will be allocated a threshold bandwidth amount necessary to ensure a clear phone communication. In this situation, the Internet browser data will be restricted to the remaining bandwidth.

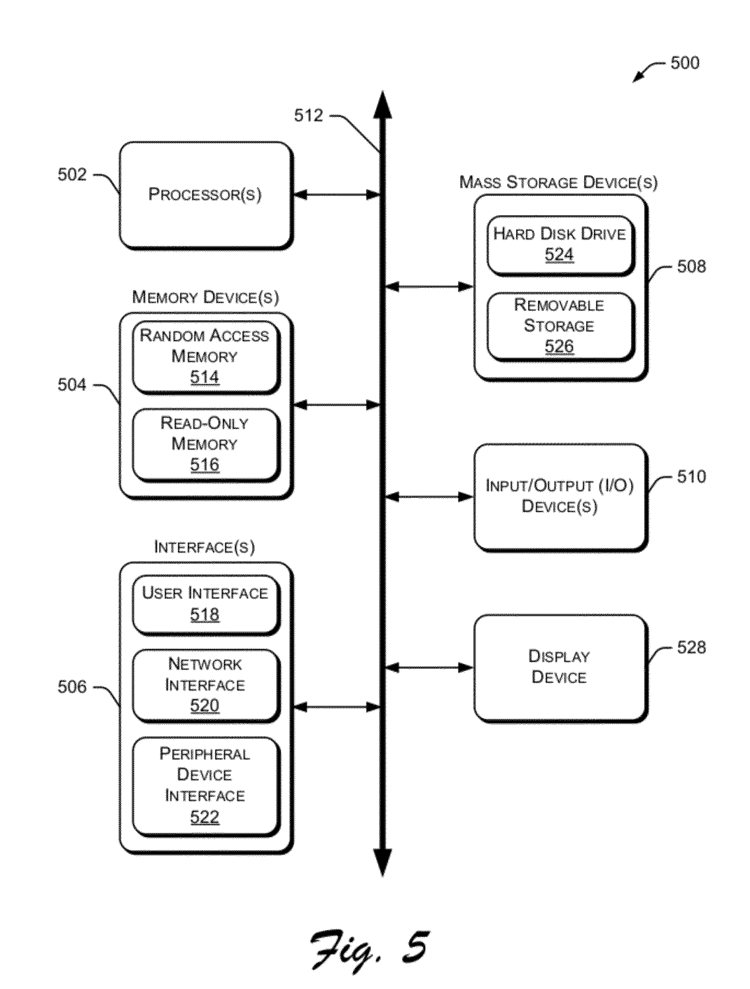

FIG. 5 is a block diagram showing an exemplary local device 500, according to one embodiment. Local device 500 may be used to perform various operations and functions, such as those discussed herein. Local device 500 can be any of a wide variety of devices, such as a portable phone, television, computing device, telephone, and the like.

Local device 500 includes one or more processor(s) 502, one or more memory device(s) 504, one or more interface(s) 506, one or more mass storage device(s) 508, one or more Input/Output (I/O) device(s) 510, and a display device 528 all of which are coupled to a bus 512. Processor(s) 502 include one or more processors or controllers that execute instructions stored in memory device(s) 504 and/or mass storage device(s) 508. Processor(s) 502 may also include various types of processor-readable media, such as cache memory.

Memory device(s) 504 include various processor-readable media, such as volatile memory (e.g., random access memory (RAM)) 514 and/or nonvolatile memory (e.g., read-only memory (ROM) 516). Memory device(s) 504 may also include rewritable ROM, such as Flash memory.

Mass storage device(s) 508 include various processor-readable media, such as magnetic tapes, magnetic disks, optical disks, solid state memory (e.g., Flash memory), and so forth. As shown in FIG. 5, a particular mass storage device is a hard disk drive 524. Various drives may also be included in mass storage device(s) 508 to enable reading from and/or writing to the various processor-readable media. Mass storage device(s) 508 include removable storage 526 and/or non-removable media.

I/O device(s) 510 include various devices that allow data and/or other information to be input to or retrieved from local device 500. Example I/O device(s) 510 include cursor control devices, keyboards, keypads, microphones, monitors or other display devices, speakers, printers, network interface cards, modems, lenses, CCDs or other image capture devices, and the like.

Display device 528 includes any type of device capable of displaying information to one or more users of local device 500. Examples of display device 528 include a display screen, monitor, display terminal, video projection device, and the like.

Interface(s) 506 include various interfaces that allow local device 500 to interact with other systems, devices, or computing environments. Example interface(s) 506 include any number of different network interfaces 520, such as interfaces to local area networks (LANs), wide area networks (WANs), wireless networks, and the Internet. Other interfaces include user interface 518 and peripheral device interface 522.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of local device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Conclusion

Although the systems and methods for communicating data have been described in language specific to structural features and/or methodological operations or actions, it is understood that the implementations defined in the appended claims are not necessarily limited to the specific features or actions described. Rather, the specific features and operations of communicating data are disclosed as exemplary forms of implementing the claimed subject matter.

1. A processor-implemented method comprising:
receiving data associated with a local device, wherein the data is received for communication between the local device and a second device;
determining whether the received data is live voice data;
assigning a priority to the received data based on whether the received data is live voice data; and
communicating the received data between the local device and the second device based on the priority assigned to the received data.

2. A method as recited in claim 1 wherein assigning a priority to the received data is further based on whether the received data is associated with a Digital Enhanced Cordless Telecommunications device.

3. A method as recited in claim 1 wherein assigning a priority to the received data is further based on whether the received data is native Unlicensed Mobile Access voice data.

4. A method as recited in claim 1 wherein assigning a priority to the received data is further based on a format associated with the received data.

5. A method as recited in claim 1 wherein assigning a priority to the received data is further based on a device type associated with the received data.

6. A method as recited in claim 1 wherein assigning a priority to the received data is further based on a service provider associated with the source of the received data.

7. A method as recited in claim 1 wherein assigning a priority to the received data is further based on a manufacturer associated with the local device.

8. A method as recited in claim 1 wherein assigning a priority to the received data is further based on a manufacturer associated with the second device.

9. A method as recited in claim 1 wherein the local device is a Digital Enhanced Cordless Telecommunications phone.

10. A method as recited in claim 1 wherein the local device is a computing device.

11. A method as recited in claim 1 wherein communicating the received data between the local device and the second device based on the priority assigned to the received data includes:
determining whether sufficient bandwidth exists to communicate the received data between the local device and the second device;
communicating the received data between the local device and the second device regardless of priority if sufficient bandwidth exists to communicate the received data between the local device and the second device; and
allocating bandwidth to the received data based on the priority assigned to the received data if insufficient bandwidth exists to communicate the received data between the local device and the second device.

12. A processor-implemented method comprising:
receiving data associated with a local device, wherein the data is received for communication between the local device and a second device;
determining whether the received data is voice-related data;
determining whether the received data is associated with a particular service provider;
assigning a priority to the received data based on whether the received data is voice-related data and based on whether the received data is associated with the particular service provider; and
communicating the received data between the local device and the second device based on the priority assigned to the received data.

13. A method as recited in claim 12 wherein priority is assigned to the received data such that voice-related data has a higher priority than non-voice-related data.

14. A method as recited in claim 12 wherein assigning a priority to the received data is further based on whether the received data is associated with a Digital Enhanced Cordless Telecommunications device.

15. A method as recited in claim 12 wherein assigning a priority to the received data is further based on whether the received data is native Unlicensed Mobile Access voice data.

16. A data communication apparatus comprising:
a processor; and
a memory coupled to the processor, the memory comprising computer-executable instructions that when executed by the processor performing operations including:
receiving data associated with a local device;
determining whether the received data is associated with a particular service provider;
assigning a data communication priority to the received data based on whether the received data is associated with the particular service provider; and
communicating the received data between the local device and a second device based on the data communication priority assigned to the received data.

17. A data communication apparatus as recited in claim 16 further comprising a communication module configured to communicate with the local device and the second device.

18. A data communication apparatus as recited in claim 16 further comprising a telephone interface configured to communicate with a conventional telephone.

19. A data communication apparatus as recited in claim 16 wherein the processor further receives data associated with a plurality of local devices.

20. A data communication apparatus as recited in claim 19 wherein the processor further assigns data communication priorities to the plurality of local devices based on whether the received data is associated with the particular service provider.
